(19) United States
(12) Patent Application Publication
(10) Pub. No.: US 2016/0203970 A1
(43) Pub. Date: Jul. 14, 2016

(54) HALOGEN LAMP

(71) Applicant: IWASAKI ELECTRIC CO., LTD., Tokyo (JP)

(72) Inventors: Akira URUSHIBARA, Saitama (JP); Katsufumi ARAI, Saitama (JP)

(73) Assignee: IWASAKI ELECTRIC CO., LTD., Tokyo (JP)

(21) Appl. No.: 14/914,441

(22) PCT Filed: Aug. 6, 2014
(86) PCT No.: PCT/JP2014/070715

§ 371 Date: Feb. 25, 2016

(30) Foreign Application Priority Data
Sep. 5, 2013 (JP) 2013-183596

(51) Int. Cl. H01K 1/18; H01K 1/14

(52) U.S. Cl. CPC H01K 1/18; H01K 1/14

(57) ABSTRACT

In a halogen lamp the middle portion of filament can be supported by support rods so as not to sag under its own weight, and the support rods are not deformed so as to bend by filament weight as the rod is not weakened by influence of high heat ray emitting from filament. A halogen lamp providing, in a glass envelope positioned horizontally at the lamp installing, a coil filament, a pair of short and long electric supply rods which support a front end and a rear end of the filament and are connected to them, and a pair of short and long support rods arranged in parallel in a lower side of the filament to support two points which are back and forth in longitudinal middle area of the filament to diagonal upward direction from the right and left underside of the filament.

### TECHNICAL FIELD

The present invention regards to a halogen lamp which is used as heat source for thermal process of semi-conductor, annealing treatment of various kind of work, prying treatment, and heating treatment.

### BACKGROUND ART

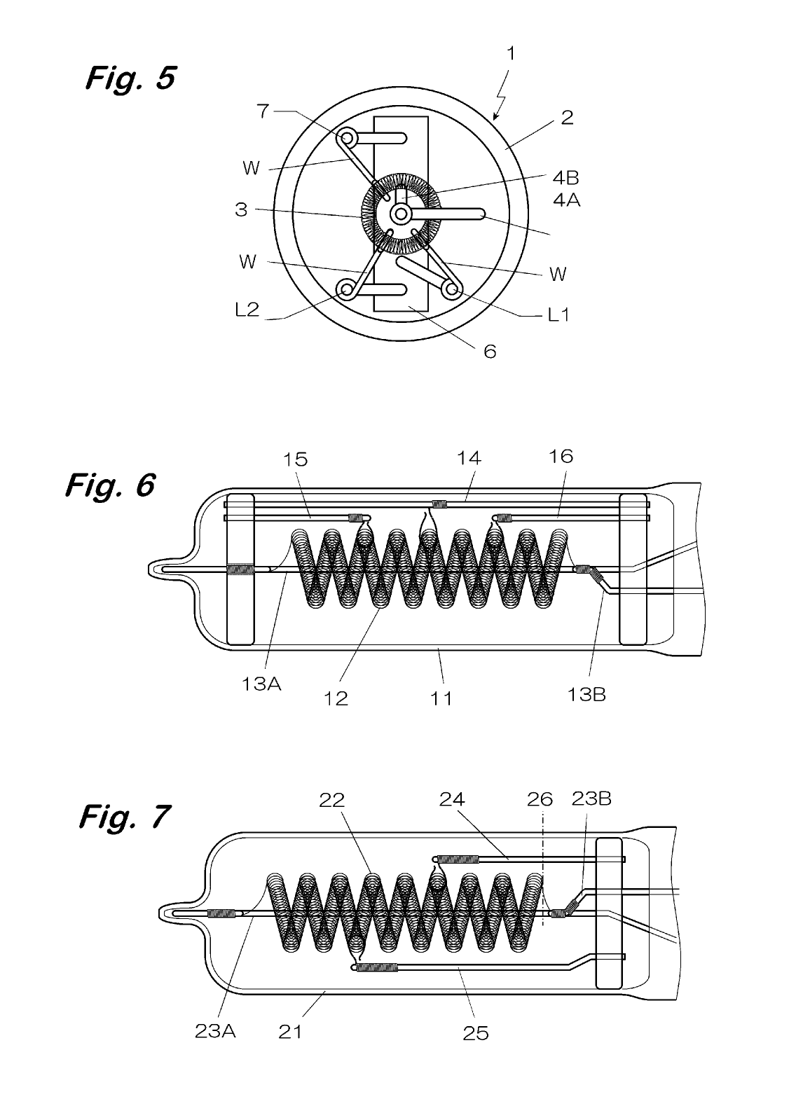

As shown in FIG. 6, this kind of the halogen lamp with a glass envelope 11 positioned horizontally at installing comprises, in the envelope, a coil filament 12 arranged along longitudinal direction of the envelope, a pair of short and long electric supply rods 13A, 13B support a front end and a rear end of the filament 12 and are connected to them, a main support rod 14 which support longitudinal middle area of the filament 12 from upper side, and first and second subsidiary support rods 15, 16 (See Patent Document 1).

The filament 12 deforms into a sagged state in the middle area thereof by thermal stress due to a repeat of on/off action of the lamp, or due to a repeat of increase/decrease of electric power.

Thereby, since the filament 12 is broken in a short term by a short circuit accident or a contact with the envelope 11, the support rods 14-16 are provided to prevent such a break.

A center portion of the filament 12 is supported by means of being hung on the main support rod 14, a portion of a quarter length from front end of filament 12 is supported by means of being hung on the first subsidiary support rods 15, and a portion of a quarter length from rear end of filament 12 is supported by means of being hung on the second subsidiary support rod 16.

Though the rod 14-16 which suspends middle area of filament 12 is made from tungsten having high heat resistance, it is arranged just above the filament 12 emitting high heat ray.

Thereby, the rod is exposed to high temperature of thermal convection generated by the high neat ray, and thermal deterioration of the rod is progressed with time, so that metal structure of tungsten of the rod is weakened and the rod deformed into bend by load of filament 12.

In this case, there is a problem that the lamp is burned out in short term by short circuit between coils of the filament 12 sagged by influence of such a deformation of the rod.

As shown in FIG. 7, another halogen lamp with a glass envelope 21 positioned horizontally at installing comprises, in the envelope, a coil filament 22 arranged along longitudinal direction of the envelope, a pair of short and long electric supply rods 23A, 23B support a front end and a rear end of the filament 22 and are connected to them, and a part of upper and lower support rods 24, 25 which support longitudinal middle area of the filament 22 from upper side and lower side (See Patent Document 2).

The upper support rod 24 is arranged just above the filament 22 to support a portion of one third length of the filament from a seal side end 26 of the glass envelope 21.

The lower support rod 25 is arranged just below the filament 22 to support a portion of two third length of the filament from a seal side end 26 of the glass envelope 21.

However, since the upper support rod 24 is arranged just above the filament 22 to support a portion of one third length of the filament from the filament end 26 of a seal side of the glass envelope 21, the rod is exposed to high temperature of thermal convection generated by the high heat ray from filament 22, and is weakened, so that the rod might deform into bend by load of filament 22.

According to such a deformation, the filament 22 is supported with only one portion which is on two thirds length of the filament from the filament end 26 of a seal side of the glass envelope 21, and the filament 22 is sagged under its own weight between the supported portion and the filament end 26, so that short circuit might occur between coils of the filament 22.

### PRIOR ART DOCUMENT

### Patent Document

Patent Document 1: JP2009-146731A

Patent Document 2: JP2945661B

### SUMMARY OF THE INVENTION

### Problems to be Solved by the Invention

It is an object of the invention to provide a halogen lamp of which the middle portion of filament can be supported by support rods so as not to sag under its own weight, the support rods which support the middle portion of filament are not deformed so as to bend by filament weight, the rod is not weakened by influence of high heat ray emitting from filament.

### Means for Solving the Problems

Means of the present invention for solving the problems is as follows;

A halogen lamp with a glass envelope positioned horizontally at installing comprising, in the envelope, a coil filament arranged along longitudinal direction of the envelope, a pair of short and long electric supply rods support a front end and a rear end of the filament and are connected to them, and support rods which support longitudinal middle area of the filament, wherein
a pair of short and long support rods are arranged in parallel on the lower side of the filament which is horizontal position at installing,
these rods respectively support two points which are back and forth in longitudinal middle area of the filament to diagonal upward direction from the right and left underside of the filament.

### Advantageous Effect of the Invention

According to the present invention, two points which are back and forth in longitudinal middle area of the filament to diagonal upward direction from the right and left underside of the filament are supported by support rods which are arranged in parallel on the lower side of the filament which is horizontal position at installing.

That is, the filament is prevented from sagging under its own weight, since two points which are back and forth in longitudinal middle area of the filament are supported by a pair of short and long support rods to diagonal upward direction from the right and left underside of the filament.

Further, since a pair of short and long support rods supporting the middle area of the filament are arranged at underside of the filament having little influence of thermal convection generated by the high heat ray emitted from filament, the rods are prevented from thermal deterioration and thermal deformation and filament is prevented from sag or torsion in influence of thermal deformation of the rods, thereby the filament is prevented from short circuit accident due to filament deformation, as that result, a long life halogen lamp can be provided.

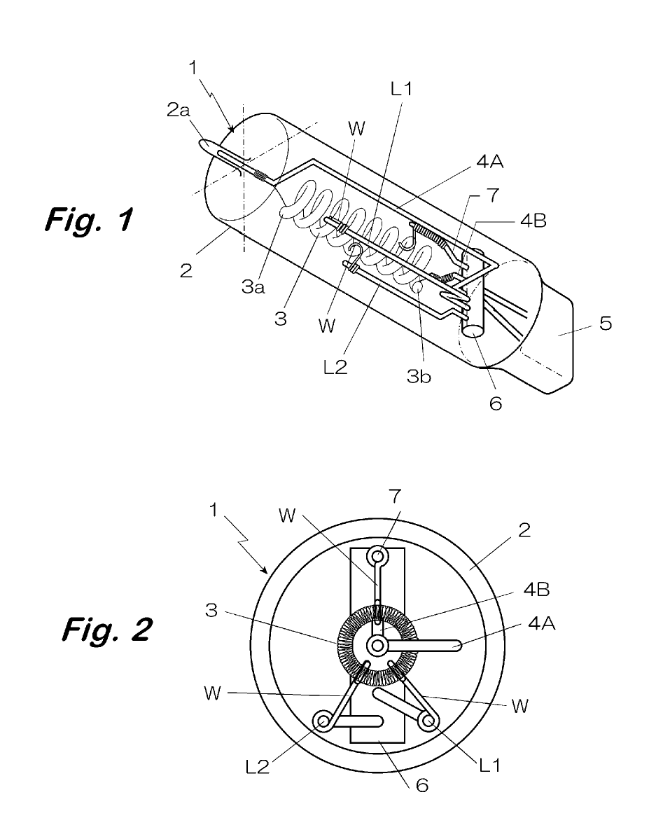

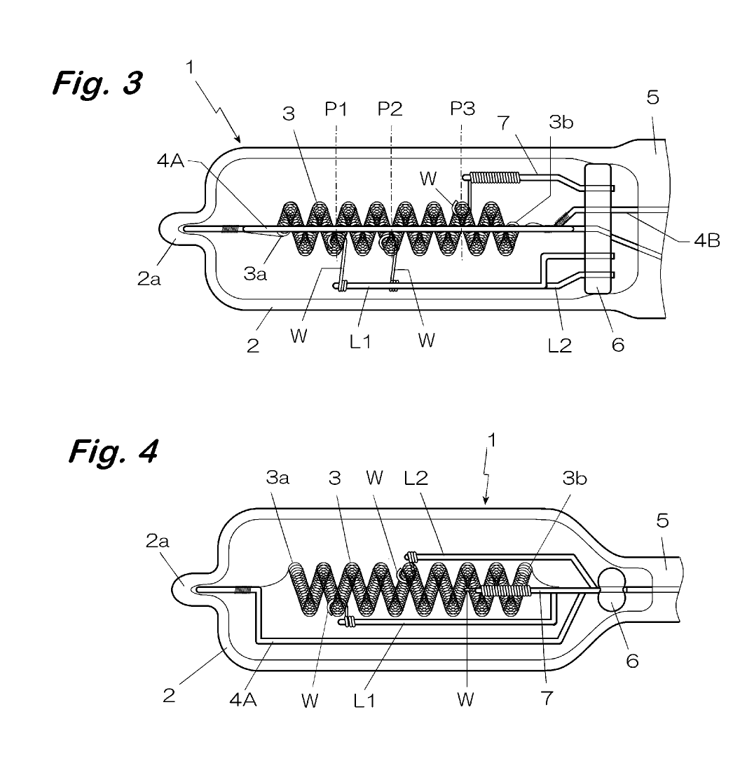

### BRIEF DESCRIPTION OF THE DRAWINGS

[FIG. 1] Perspective view showing an embodiment of a halogen lamp according to the invention.

[FIG. 2] Front view of the halogen lamp of FIG. 1.

[FIG. 3] Side view of the halogen lamp of FIG. 1.

[FIG. 4] Top view of the halogen lamp of FIG. 1

[FIG. 5] Top view of a modified embodiment due to modifying the part of constitution of the halogen lamp of FIG. 1.

[FIG. 6] Side view of conventional halogen lamp.

[FIG. 7] Side view of another conventional halogen lamp.

### EXAMPLES FOR CARRYING OUT THE INVENTION

According to the invention, a halogen lamp with a glass envelope positioned horizontally at installing comprising, in the envelope, a coil filament arranged along longitudinal direction of the envelope, a pair of short and long electric supply rods support a front end and a rear end of the filament and are connected to them, and support rods which support longitudinal middle area of the filament, wherein
a pair of short and long support rods are arranged in parallel on the lower side of the filament which is horizontal position at installing,
these rods respectively support two points, for example a front side point and a center side point, which are back and forth in longitudinal middle area of the filament to diagonal upward direction from the right and left underside of the filament.

Further, for the lamp having a relatively long filament, a subsidiary support rod which supports subsidiarily a rear side point of the longitudinal middle area of the filament is arranged on the upper side of the filament.

### Embodiment

A halogen lamp 1 as an embodiment of the invention has a glass envelope 2 positioned horizontally at installing in the envelope, a coil filament 3 is arranged along longitudinal direction of the envelope 2, and a pair of short and long electric supply rods 4A, 4B support a front end 3a and a rear end 3b of the filament and are connected to them.

Additionally, the filament 3 is a larger diameter coiled coil made by coiling a smaller diameter single coil spirally which is made by coiling simple wire of tungsten spirally.

The electric supply rods 4A, 4B are sealed into a seal portion 5 of the glass envelope 2 by thermo-compression bonding, and one end thereof is connected to a outer-electrode (not shown) which extends to outside of glass envelope 2, another end thereof extends into the envelope 2 through a cylindrical glass bead 6 arranged near the seal portion 5.

The long electric supply rod 4A is bent into crank-shape so as not to contact to the filament 3, a front end of the rod 4A is supported by means of inserting into chip-off portion 2a of the glass envelope 2, and the front end 3a of the filament 3 is supported by means of connecting to the front end of the rod.

Further, a rear end 3b of the filament 3 positioned in a side of the seal portion 5 is connected to an end of the short electric supply rod 4B.

In the glass envelope 2, a pair of short and long support rods L1, L2 which respectively support two points which are back and forth in longitudinal middle area of the filament 3 to diagonal upward direction from the right and left underside of the filament 3 are arranged in parallel on the lower side of the filament 3 which is horizontal position at installing.

The support rods L1, L2 are supported into cantilever fashion by means of inserting a rear end thereof into the glass bead 6, rear sides thereof are bent into crank-shape toward oblique right and left underside of the filament 3 in rear side so as to be arranged in oblique right and left underside of the filament 3, and front sides thereof extend in parallel along longitudinal direction of the filament 3.

A front side point P1 of filament 3 at a portion of a quarter filament length from front end of filament 3 supported upwardly from lower right of the filament 3 as shown in the front view by the long support rod L1.

A center point P2 of filament 3 at a portion of a half filament length is supported upwardly from lower left of the filament 3 as shown in the front view by the short support rod L2.

Hook-like-wire W is attached to each front end of support rods L1, L2 in order to grapple the filament 3.

Thereby, the coil filament 3 is prevent from deforming into a sagged state in the middle area thereof under its own weight, since the middle area of filament 3 is supported at the front side point P1 and the center point P2 a pair of long and short support rod L1, L2 to diagonal upward direction from the right and left underside thereof.

That is, since two portions which are a front side point P1 and a center side point P2 f the filament 3 are supported from the right and left underside thereof by a pair of long and short support rod L1 and L2, the filament 3 has so called “obliquely-crossing support effect”, the filament is prevented from sagging at middle area thereof, as that result, the coils of the filament 3 is prevented from short circuit accident.

Further, since a pair of long and short support rods L1 and L2 which support middle area of filament 3 are arranged under the filament 3 so as to have little influence of thermal convection generated by the high heat ray emitted from filament at lighting halogen lamp 1, the filament 3 is prevented from deformation of sag or torsion due to deformation of the support rod L1, L2.

Thereby the filament is prevented from short circuit accident due to filament deformation, as that result, a long life halogen lamp can be provided.

Additionally, when the coil filament 3 has relatively long filament length, a subsidiary support rod 7 which supports subsidiarily a rear side point P3 of the longitudinal middle area of the filament 3 is arranged on the upper side of the filament 3, as shown in Drawings.

Since not only the rod 7 needs short length, but also it arranged. in the side of the seal-portion with lower temperature than a front side and a center side of glass envelope 2, thermal deformation does not occur in the subsidiary support rod 7 which support the rear side point P3 of the longitudinal middle area of the filament 3 even if it is arranged just above the filament 3 as shown in FIG. 2.

When the subsidiary support rod 7 is arranged at the offset position to right side or left side so as to avoid the position just above the filament 3 as shown in FIG. 5, degree of thermal deformation becomes less.

Therefore, the filament 3 is prevented from sag or torsion due to thermal deformation of the subsidiary support rod 7.

When filament length of the coil filament 3 is relatively short, the subsidiary support rod 7 does not need to be arranged, since the filament 3 is surely prevented from sag under its own weight.

Further, though a pair of long and short support rods respectively support two points which are back and forth in longitudinal middle area of the coil filament to diagonal upward direction from the right and left underside of the filament, and the rods of the embodiment support the front side point of filament 3 at a portion of a quarter filament length from front end of filament 3 and the center point of filament 3 at a portion of a half filament length is supported, this invention is not limited such as embodiment.

For example, the rods can support a portion of a one thirds filament length from front end of filament and a portion of a two thirds filament length from front end of filament.

### EXPLANATION OF REFERENCES

1 Halogen lamp

2 Glass envelope

3 Coil filament

4A Electric supply rod

4B Electric supply rod

5 Seal portion of glass envelope

6 Glass bead

L1 Support rod

L2 Support rod

P1 Front portion of middle area of filament

P2 Center portion of middle area of filament

7 Subsidiary support rod

P3 Rear portion of middle area of filament

1. A halogen lamp with a glass envelope positioned horizontally at installing comprising, in the envelope, a coil filament arranged along longitudinal direction of the envelope, a pair of short and long electric supply rods support a front end and a rear end of the filament and are connected to them, and support rods which support longitudinal middle area of the filament, wherein
a pair of short and long support rods are arranged in parallel on the lower side of the filament which is horizontal position at installing,
these rods respectively support two points which are back and forth in longitudinal middle area of the filament to diagonal upward direction from the right and left underside of the filament.

2. A halogen lamp according to the claim 1, wherein
a front side point and a center side point of the longitudinal middle area of the filament are supported by a pair of the short and long support rods.

3. A halogen lamp according to the claim 1, wherein
a subsidiary support rod which supports subsidiarily a rear side point of the longitudinal middle area of the filament is arranged on the upper side of the filament.

4. A halogen lamp according to the claim 2, wherein
a subsidiary support rod which supports subsidiarily a rear side point of the longitudinal middle area of the filament is arranged on the upper side of the filament.
